(19) United States
(12) Patent Application Publication
(10) Pub. No.: US 2026/0342949 A1
(43) Pub. Date: Oct. 29, 2026

(54) IMAGE PROJECTION METHOD AND PROJECTION SYSTEM

(71) Applicant: COMPAL ELECTRONICS, INC., Taipei City (TW)

(72) Inventors: Pin-Yu Chou, Taipei City (TW); Chuan-Yu Liu, Taipei City (TW); Chun-Yen Yu, Taipei City (TW); Ming-Hsien Wu, Taipei City (TW)

(73) Assignee: COMPAL ELECTRONICS, INC., Taipei City (TW)

(21) Appl. No.: 19/632,437

(22) Filed: Mar. 30, 2026

Related U.S. Application Data
(60) Provisional application No. 63/796,401, filed on Apr. 29, 2025.

(51) Int. Cl. H04N 9/31

(52) U.S. Cl. CPC H04N 9/3185; H04N 9/3194

(57) ABSTRACT

An image projection method and a projection system are provided. In the method, a captured image corresponding to a projection range of a projector is obtained. An object area and a shadow area are identified from the captured image. The object area corresponds to an object, and the object area is connected to the shadow area. A projection area within the projection range is determined according to the object area and the shadow area. The object area and the shadow area are outside the projection area. Extended information of the object is generated, and the extended information is projected to the projection area through the projector. An artificial intelligence model is used to detect and avoid the shadow area, and completeness and visibility of the projected information are ensured accordingly.

### CROSS-REFERENCE TO RELATED APPLICATION

This application claims the priority benefit of U.S. provisional application serial no. 63/796,401, filed on Apr.29, 2025. The entirety of the above-mentioned patent application is hereby incorporated by reference herein and made a part of this specification.

### BACKGROUND

### Technical Field

The disclosure relates to a projection technology, and more particularly, to an image projection method and a projection system.

### DESCRIPTION OF RELATED ART

Traditional desktop projection technology typically assumes a projection surface to be an open and flat surface. However, in practical application scenarios, desktops are often placed with various physical objects. Physical heights of these objects may block a projection light path, causing projection information to be obscured. Meanwhile, interaction between ambient light sources and projection light may generate dark areas around objects. Limited by a design of fixed projection areas, existing projection display methods often have difficulty adapting to dynamically changing desktop environments, making content of display information prone to overlapping physical obstacles, thereby affecting identification quality of a user.

### SUMMARY

The disclosure provides an image projection method and a projection system that may identify objects and shadows in a projection environment and guide projection information to unobstructed areas.

An image projection method in the embodiment of the disclosure is implemented by a processor. The image projection method includes (but is not limited to) the following. A captured image is obtained. The captured image corresponds to a projection range of a projector. An object area and a shadow area are identified from the captured image. The object area corresponds to at least one object, and the object area is connected to the shadow area. A projection area within the projection range is determined according to the object area and the shadow area. The object area and the shadow area are outside the projection area. Extended information of the object is generated. The extended information is projected to the projection area through the projector.

A projection system in the embodiment of the disclosure includes (but is not limited to) a projector, an image capturing device, and a processor. The image capturing device is configured to obtain a captured image. The processor is communicatively connected to the projector and the image capturing device, and is configured to: obtain the captured image, in which the captured image corresponds to a projection range of the projector; identify an object area and a shadow area from the captured image, in which the object area corresponds to at least one object, and the object area is connected to the shadow area; determine a projection area within the projection range according to the object area and the shadow area, in which the object area and the shadow area are outside the projection area; generate extended information of the object; and project the extended information to the projection area through the projector.

Based on the above, the image projection method and the projection system in the embodiments of the disclosure may identify in real time a relative relationship between the objects and the shadows in the environment, dynamically define the projection area available for projection, and display the extended information in this projection area. Thereby, not only may projection content be prevented from being obscured, but also the extended information may be ensured to have good visibility under different projection scales.

In order for the aforementioned features and advantages of the disclosure to be more comprehensible, embodiments accompanied with drawings are described in detail below.

### BRIEF DESCRIPTION OF THE DRAWINGS

FIG. 1 is a block diagram of elements of a projection system according to an embodiment of the disclosure.

FIGS. 2A-2C are schematic diagrams illustrating a relative relationship between a projector and a projection surface according to an embodiment of the disclosure.

FIGS. 3A-3C are schematic diagrams illustrating captured images of different relative relationships according to an embodiment of the disclosure.

FIG. 4 is a flowchart of an image projection method according to an embodiment of the disclosure.

FIGS. 5A and 5B are schematic diagrams illustrating a shadow according to an embodiment of the disclosure.

FIG. 6 is a flowchart illustrating determination of an active area according to an embodiment of the disclosure.

FIGS. 7A and 7B are schematic diagrams of an active area according to an embodiment of the disclosure.

FIG. 8 is a flowchart illustrating determination of a shadow area according to an embodiment of the disclosure.

FIGS. 9A and 9B are schematic diagrams of segmentation of a shadow area according to an embodiment of the disclosure.

FIG. 10 is a flowchart illustrating determination of a shadow area according to another embodiment of the disclosure.

FIGS. 11A-11E are schematic diagrams of segmentation of a shadow area according to another embodiment of the disclosure.

FIG. 12 is a flowchart illustrating determination of a shadow area according to still another embodiment of the disclosure.

FIGS. 13A-13C are schematic diagrams of segmentation of a shadow area according to still another embodiment of the disclosure.

FIG. 14 is a flowchart illustrating determination of a shadow area according to yet another embodiment of the disclosure.

FIGS. 15A-15F are schematic diagrams illustrating sizes of a projection range and extended information according to an embodiment of the disclosure.

FIG. 16 is a flowchart illustrating determination of a display direction according to an embodiment of the disclosure.

FIGS. 17A-17F are schematic diagrams illustrating extended information and a display direction thereof according to an embodiment of the disclosure.

FIG. 18 is a schematic diagram illustrating a connected boundary and an active area according to an embodiment of the disclosure.

FIG. 19 is a schematic diagram illustrating an active area according to an embodiment of the disclosure.

FIGS. 20A and 20B are schematic diagrams illustrating dynamic adjustment of an active area according to an embodiment of the disclosure.

FIG. 21 is a flowchart illustrating position adjustment of prompt information according to an embodiment of the disclosure.

FIGS. 22A-22C are schematic diagrams illustrating position determination of prompt information according to an embodiment of the disclosure.

FIG. 23 is a flowchart illustrating a change in a projection position according to an embodiment of the disclosure.

FIGS. 24A-24D are schematic diagrams illustrating detection of area change and change of a projection position according to an embodiment of the disclosure.

### DETAILED DESCRIPTION OF DISCLOSED EMBODIMENTS

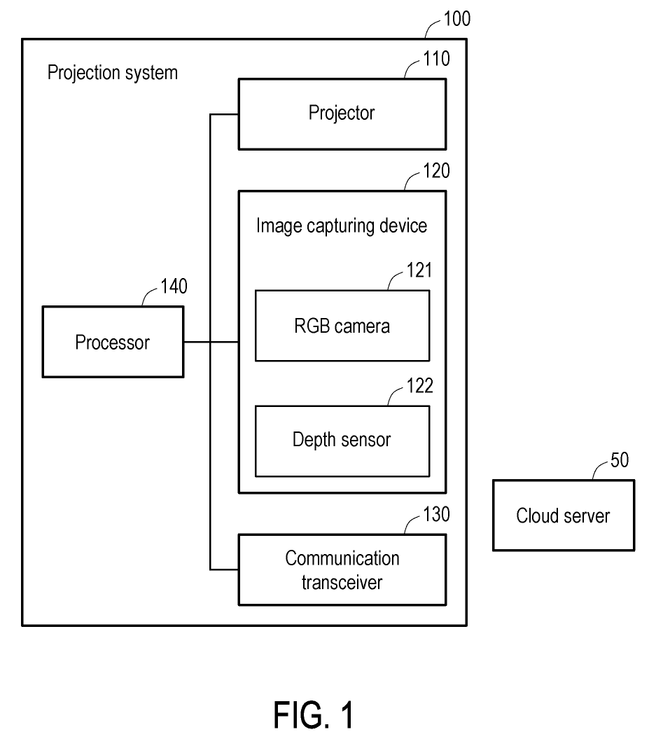

FIG. 1 is a block diagram of elements of a projection system 100 according to an embodiment of the disclosure. Referring to FIG. 1, the projection system 100 is applicable to projection scenarios such as desktop interaction, smart home, or commercial display (but not limited thereto). In some application scenarios, the projection system 100 is used to identify positions of objects and shadows in an environment in real time, and dynamically adjust a display range of projection information to avoid information being obscured.

The projection system 100 includes (but is not limited to) a projector 110, an image capturing device 120, a communication transceiver 130, and a processor 140.

For example, it is a liquid crystal projector (LCD projector), a digital light processing projector (DLP projector), or a laser projector (laser projector). In one embodiment, the projector 110 is used to receive image signals output by the processor 140 and project corresponding images onto a projection surface (for example, a wall, a projection screen, a whiteboard, or other surfaces).

In some application scenarios, when the projection system 100 is installed in a desktop environment, the projector 110 may project interactive interfaces, text descriptions, or auxiliary images (i.e., extended information) related to physical objects onto a specific blank area of a desktop.

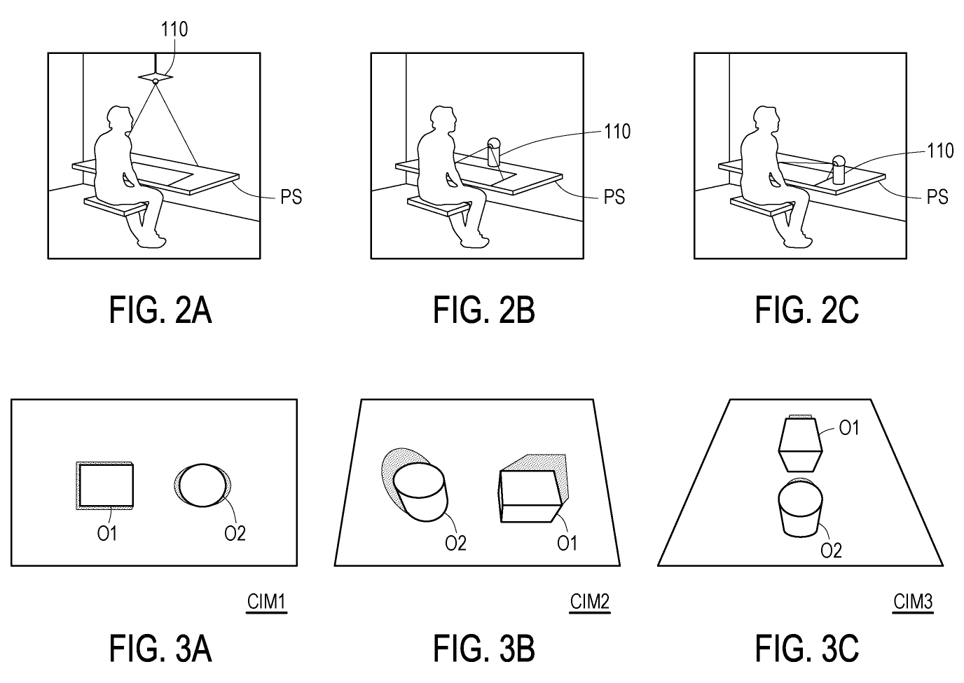

The projector 110 may have different projection methods. FIGS. 2A-2C are schematic diagrams illustrating a relative relationship between the projector 110 and a projection surface PS according to an embodiment of the disclosure. The projector 110 may have different installation methods according to space limitations of an application environment. For example, as shown in FIG. 2A, the projector 110 may be installed by suspension directly above the projection surface PS (such as the desktop) to perform orthogonal projection toward the projection surface PS. As shown in FIG. 2B, the projector 110 may be placed on a side of the projection surface PS and perform horizontal projection toward the projection surface PS at a low-side angle. As shown in FIG. 2C, the projector 110 may also be placed on the side of the projection surface PS and perform vertical projection toward the projection surface PS. Through the above different installation angles, the projector 110 may flexibly define a projection range.

It is worth noting that different projection methods may cause different shadow states. For example, FIGS. 3A-3C are schematic diagrams illustrating captured images of different relative relationships according to an embodiment of the disclosure. Referring to FIGS. 2A and 3A , under the orthogonal projection as shown in FIG. 2A, a corresponding captured image CIM1 presents a front top-view angle. In addition, since projection light is projected nearly vertically, shadows generated by objects O1 and O2 are smaller and mostly located directly below the objects. Referring to FIGS. 2B and 3B , under the orthogonal projection as shown in FIG. 2B, in a corresponding captured image CIM2, limited by a low lateral projection angle, the objects O1 and O2 will generate elongated shadows on the projection surface PS along a projection direction. Referring to FIGS. 2C and 3C , under the vertical projection as shown in FIG. 2C, in a corresponding captured image CIM3, the shadows will present extended shapes with different orientations according to a placement position of the projector 110. These shadows may cause images projected to these areas to generate visual discontinuities or distortions.

The image capturing device 120 includes an RGB (red, green, blue) camera 121 and a depth sensor 122. The RGB camera 121 may be a color camera, and is used to obtain color, texture, and light and shadow changes on the projection surface PS as shown in FIGS. 2A-2C . On the other hand, the depth sensor 122 may be a time-of-flight sensor, a structured light sensor, or a stereo vision camera, and is used to detect a distance of each of sensing points within the projection range. For example, as shown in FIG. 3B, the processor 140 captures features including the object O1 through the RGB camera 121, and may cooperate with depth information provided by the depth sensor 122 to accurately distinguish the object O1 itself having a height/depth.

In one embodiment, the image capturing device 120 is used to capture the projection range corresponding to the projector 110. As shown in FIGS. 2A and 3A , a field of view of the image capturing device 120 fully or partially covers/overlaps the projection range of the image projected by the projector 110. In one embodiment, the RGB (red, green, blue) camera 121 and the depth sensor 122 are integrated as a single module, for example, an RGB-D camera.

The communication transceiver 130 is, for example, a communication transceiver circuit supporting Wi-Fi, Bluetooth, or mobile networks, and is used to establish data connections between the projection system 100 and external devices. For example, as shown in FIG. 1, the projection system 100 may transmit the captured images CIM1 to CIM3 to a cloud server 50 through the communication transceiver 130. The cloud server 50 may utilize high-performance computing resources to perform artificial intelligence (AI) analysis on complex light and shadow in the images. In one embodiment, the communication transceiver 130 is used to enable the projection system 100 to exchange data with the external devices (for example, smart home devices) or networks.

The processor 140 is communicatively connected to the projector 110, the image capturing device 120, and the communication transceiver 130, respectively. The processor 140 may be a central processing unit (CPU), a graphic processing unit (GPU), an application-specific integrated circuit (ASIC), or a combination thereof. In one embodiment, the processor 140 is used to execute the image projection method described in the embodiments of the disclosure, and may load and execute various program codes, software modules, and/or data stored in a memory (not shown).

For the convenience of understanding an operation process of the embodiments of the disclosure, the following will describe the operation process of the embodiments of the disclosure in detail with numerous embodiments, and explain the method described in the embodiments of the disclosure in conjunction with the elements or devices in FIGS. 1-3C .

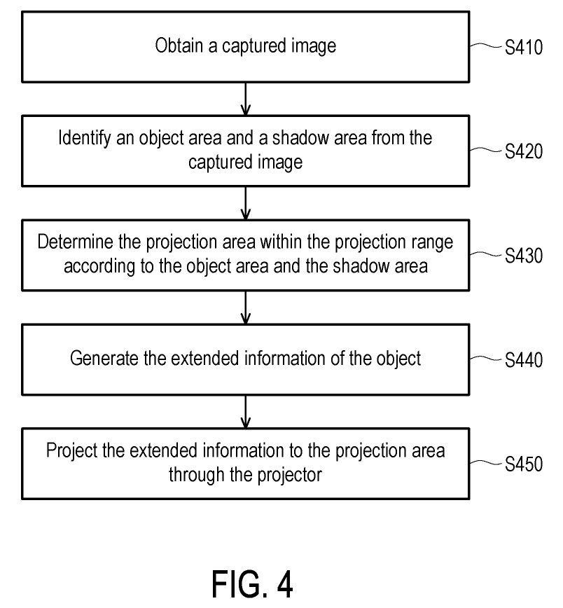

FIG. 4 is a flowchart of an image projection method according to an embodiment of the disclosure. Referring to FIG. 4, in step S410, the processor 140 obtains a captured image through the image capturing device 120. Specifically, the processor 140 captures image information of the current projection surface PS through the RGB camera 121 and/or the depth sensor 122. The captured image corresponds to the projection range of the projector 110, that is, a capturing angle of view of the image capturing device 120 covers a physical area where the projector 110 may project the images. For example, as shown in FIG. 3A, the processor 140 obtains the captured image CIM1 including the objects O1 and O2. Therefore, this captured image CIM1 reflects a spatial layout of the objects and the projection surface PS.

In step S420, the processor 140 identifies an object area and a shadow area from the captured image. Specifically, this step is used to distinguish a range occupied by the physical objects (such as the objects O1 and O2 shown in FIGS. 3A-3C ) on the projection surface PS, and a dark range (i.e., the shadows) generated by the objects blocking the projection light. The object area corresponds to one or more objects (such as the objects O1 and O2 in FIGS. 3A-3C ), while the shadow area is a dark range connected to the object area. The object area is connected to the shadow area.

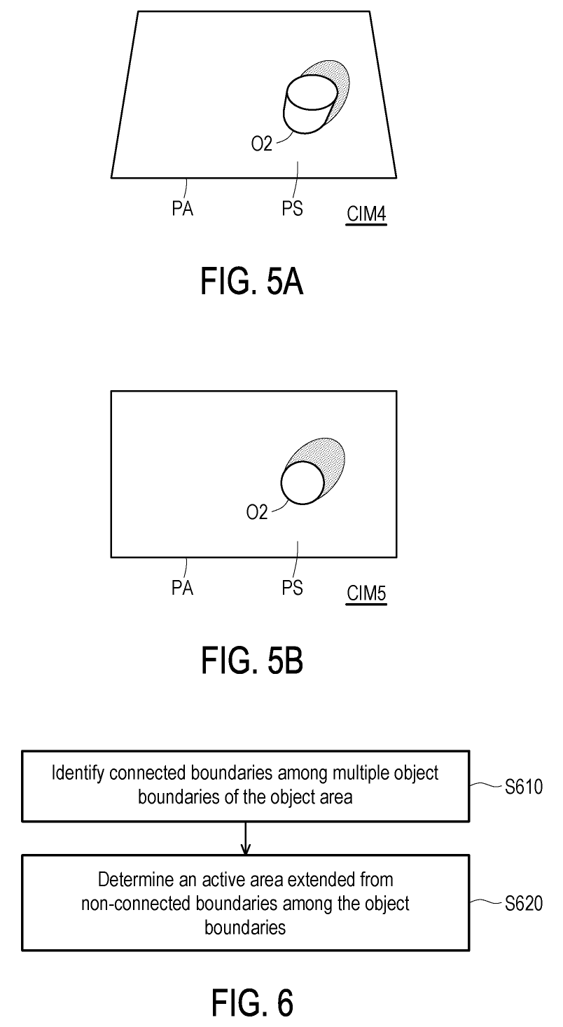

For example, FIG. 5A is a schematic diagram illustrating a shadow according to an embodiment of the disclosure. Referring to FIG. 5A, a captured image CIM4 is an image from an angle of view of the projector 110, and a projection range PA on the projection surface PS for presenting the image is captured. FIG. 5B is a schematic diagram illustrating the shadow according to the embodiment of the disclosure. Referring to FIG. 5B, a captured image CIM5 is a top-view image of the projection surface PS. Compared to FIG. 5A, due to different angles of view, a position of the shadow is different.

Regardless, the position where the shadow is located is connected to the corresponding object O2. Since the physical object corresponding to the object area will block a light path, the shadow area will be physically connected to a boundary of the object area. At this time, the processor 140 may identify the object area through an artificial intelligence model provided by built-in or the cloud server 50, and further identify the shadow area by combining image features (such as color, brightness, and depth difference).

FIG. 6 is a flowchart illustrating determination of an active area according to an embodiment of the disclosure. Referring to FIG. 6, in step S610, the processor 140 may identify one or more connected boundaries among multiple object boundaries of the object area. Specifically, the connected boundaries are boundaries among edges of the object area that are in direct contact with, overlap, or are continuous with the shadow area in physical space or image coordinates. That is, the connected boundaries are connected to the shadow area.

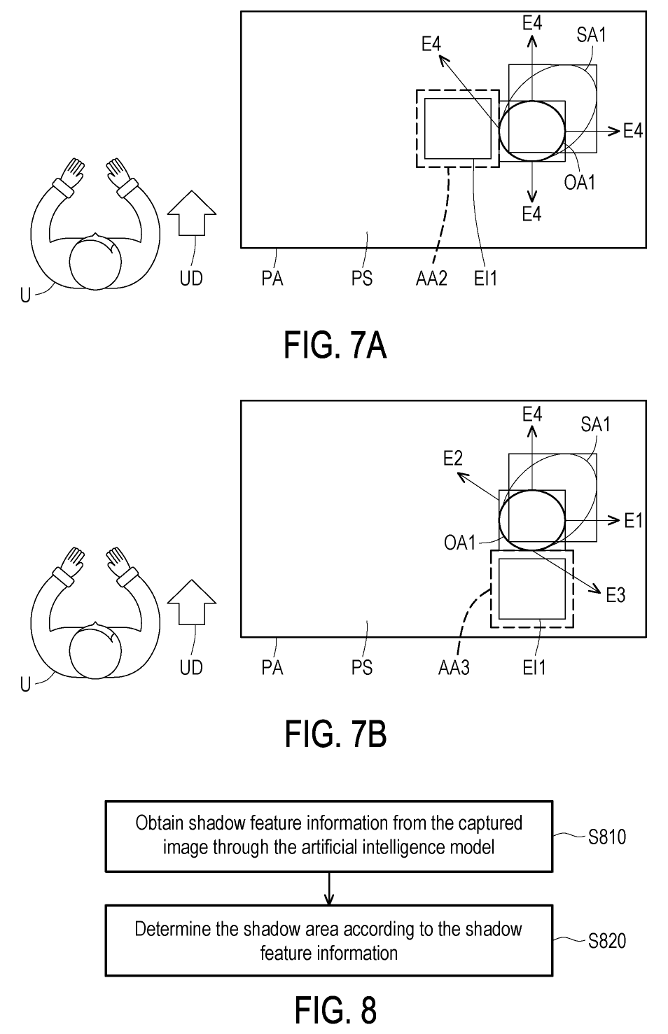

For example, FIGS. 7A and 7B are schematic diagrams of active areas AA2 and AA3 according to an embodiment of the disclosure. Taking FIG. 7A as an example, it is assumed that a sight direction UD of a user U corresponds to an upper part of the drawing. An object area OA1 corresponding to the object O2 has multiple object boundaries E1, E2, E3, and E4 (for example, the artificial intelligence model selects the object O2 with a quadrilateral bounding box, but a shape of the bounding box is not limited to a quadrilateral). The processor 140 analyzes the image features around the object area OA1, and detects that the object boundary E1 and the object boundary E4 are connected to a shadow area SA1. Therefore, the object boundary E1 and the object boundary E4 are identified as connected boundaries, while the object boundary E2 and the object boundary E3 are identified as non-connected boundaries (i.e., not connected to the shadow area SA1).

Regarding the identification of the object area OA1 and the shadow area SA1, the processor 140 may, for example, identify a contour of the object area OA1 through the artificial intelligence model, and further identify the shadow area SA1 by combining the image features (such as the color, the brightness, and the depth difference). Various specific implementation methods for area identification will be described in detail in subsequent embodiments.

Referring to FIG. 6, in step S620, the processor 140 may determine an active area extended from non-connected boundaries among the object boundaries. Specifically, this step is used to form available display blocks by extending outward a preset distance from the object boundaries that are not shadowed. The processor 140 may identify the non-connected boundaries that are not connected to the shadow area (such as the object boundary E2 and the object boundary E3 in FIG. 7A), and expand outward from these non-connected boundaries by a specific range to form the active area. That is, the non-connected boundaries are not connected to the shadow area, and a projection area includes an active area extended from one or more non-connected portions.

For example, as shown in FIG. 7A, the processor 140 extends the active area AA2 from the non-connected object boundary E2. Alternatively, as shown in FIG. 7B, the processor 140 extends the active area AA3 from the non-connected object boundary E3. It is worth noting that the projection area corresponding to extended information E1 projected by the projector 110 (i.e., an area where the extended information E1 is imaged on the projection surface PS) may be these active areas AA2 and AA3. In some application scenarios, to ensure that display content (for example, the extended information E1) does not overlap the object (for example, the object O2), coordinate correction may be performed on the active areas AA2 and AA3 during a determination process, for example, converting a shadow-covered portion into a rectangle and then expanding outward by N millimeters (mm) as a buffer space.

Additionally, when determining the active area, the processor 140 may determine whether a size of the active area meets a preset threshold value. For example, if a width or a height of a rectangular area extended from a certain non-connected boundary is less than a threshold value M (such as 5 pixels or a specific physical length), the processor 140 may mark this area as a non-projectable area rather than defining it as an active area. Thereby, it may be ensured that the finally generated projection area has sufficient space to completely display the extended information.

FIG. 8 is a flowchart illustrating determination of a shadow area according to an embodiment of the disclosure. This flowchart illustrates the first implementation aspect of identifying the shadow area in the aforementioned step S420, namely, directly performing shadow detection by using the artificial intelligence model. The determination of the shadow area is, for example, to analyze feature points in the captured image by using a pre-trained algorithm model to identify pixel sets belonging to shadows in the image. The processor 140 may transmit the captured image to the artificial intelligence model built into the projection system 100 or located on the cloud server 50, and the artificial intelligence model extracts visual features corresponding to the shadows.

Referring to FIG. 8, in step S810, the processor 140 may obtain shadow feature information from the captured image through the artificial intelligence model. Specifically, the processor 140 may extract feature information related to a shadow contour, a depth, or a brightness gradient from the captured image. The shadow feature information corresponds to contour information of the shadow area. For example, the artificial intelligence model may perform inference on the captured image based on a convolutional neural network (CNN) or an image segmentation model (such as Mask R-CNN), thereby outputting coordinate sets or masks representing shadow boundaries.

In step S820, the processor 140 may determine the shadow area according to the shadow feature information. Specifically, the processor 140 may define a coverage range of physical shadows in a coordinate system of the projection surface PS according to the extracted visual features (i.e., the shadow feature information). The processor 140 filters the feature points that do not meet preset conditions and marks a confirmed contour area as the shadow area.

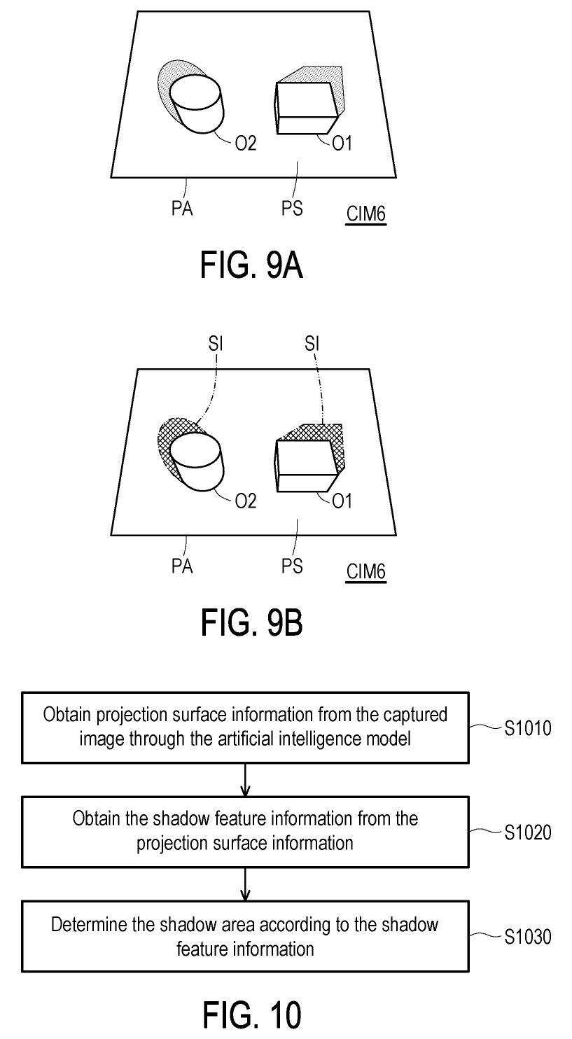

For example, FIGS. 9A and 9B are schematic diagrams of segmentation of a shadow area according to an embodiment of the disclosure. Referring to FIG. 9A, the processor 140 obtains a captured image CIM6 through the image capturing device 120, which shows the objects O1 and O2, and surrounding backgrounds thereof. Next, referring to FIG. 9B, the processor 140 identifies shadow feature information SI connected to the object area in the captured image CIM6. Through an identification capability of the artificial intelligence model, even in situations where a background environment is relatively complex or an ambient light source is uneven, the processor 140 may still accurately separate dark areas beside the objects O1 and O2 from the objects themselves, and identify the shadow area.

FIG. 10 is a flowchart illustrating determination of a shadow area according to another embodiment of the disclosure. This flowchart illustrates the second implementation aspect of identifying the shadow area, namely, first locating a projection surface range, then filtering out shadow features therein. This method may more precisely exclude interference from non-projection surfaces (such as wall backgrounds or sides of three-dimensional objects).

Referring to FIG. 10, in step S1010, the processor 140 may obtain projection surface information from the captured image through the artificial intelligence model. Specifically, image semantic segmentation technology is used to identify a pixel range belonging to a projectable medium (such as a desktop plane) in the captured image. The projection surface information corresponds to contour information of the projection surface (such as the desktop) within the projection range. The artificial intelligence model may identify a flat planar area in the captured image that are suitable for receiving the projection light, and exclude a cluttered background that does not belong to the projection surface.

In step S1020, the processor 140 may obtain the shadow feature information from the projection surface information. Specifically, within the defined projection surface range, blocks with abnormal brightness values or presenting specific grayscale distributions are searched. Since the shadows physically exist on the projection surface, by narrowing a search range to the projection surface information, the processor 140 may more effectively capture the contour information corresponding to the shadow area.

In step S1030, the processor 140 may determine the shadow area according to the shadow feature information. Specifically, the extracted shadow features are converted into spatial coordinates to define the non-projectable area. The processor 140 may integrate the projection surface information and the shadow feature information to confirm an actual occupied position of the shadow on the projection surface PS.

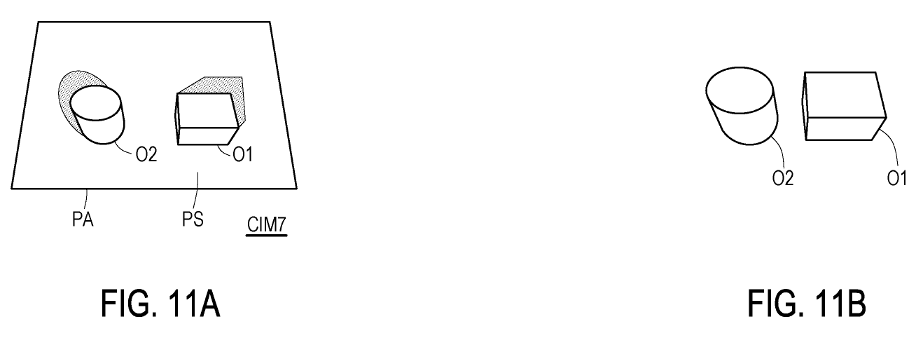

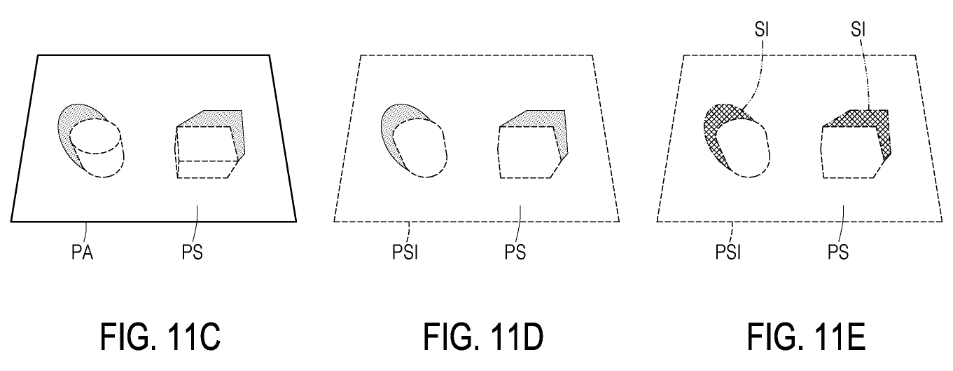

For example, FIGS. 11A-11E are schematic diagrams of segmentation of a shadow area according to another embodiment of the disclosure. Referring to FIG. 11A first, the processor 140 obtains a captured image CIM7 including the objects O1 and O2.

Referring to FIGS. 11B and 11C , the processor 140 identifies and separates the object areas corresponding to the objects O1 and O2 through the artificial intelligence model (as shown in FIG. 11B), and then precisely segments an area where the projection surface PS is located (as shown in FIG. 11C, that is, other areas on the projection surface PS excluding the object areas).

Referring to FIG. 11D, the processor 140 detects projection surface information PSI with a darker color within a range of the projection surface PS. Referring to FIG. 11E, the processor 140 determines the shadow feature information SI from the projection surface information PSI. For example, the shadow feature information SI involves areas with darker colors, and accordingly determines the shadow area corresponding to contour features of the shadow feature information SI. Through this strategy of first finding the projection surface and then detecting the shadows, the projection system 100 may still maintain extremely high shadow identification accuracy even under complex ambient lighting conditions.

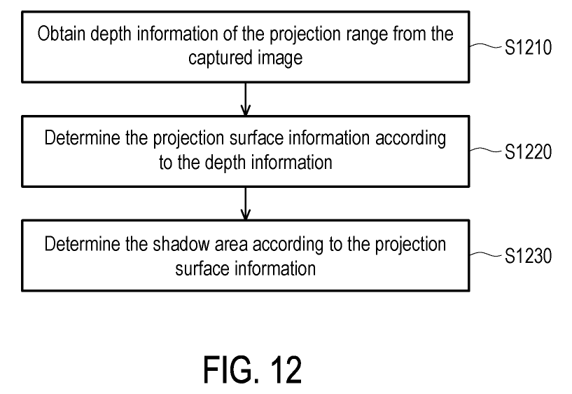

FIG. 12 is a flowchart illustrating determination of a shadow area according to still another embodiment of the disclosure. This flowchart describes the third implementation aspect of identifying the shadow area, namely, distinguishing the object from the plane by using a physical height difference and locking onto a dark position on the projection surface. This method may effectively solve an issue of difficult identification when an object color is similar to a shadow color.

Referring to FIG. 12, in step S1210, the processor 140 may obtain depth information of the projection range from the captured image. Specifically, physical distance values (i.e., height or depth data) of each of the sensing points within the projection range relative to the image capturing device 120 are recorded. The processor 140 may detect the projection surface PS and objects thereabove through the depth sensor 122 (such as the time-of-flight sensor or the structured light sensor), and obtain the depth data including the spatial coordinates and distance values.

In step S1220, the processor 140 may determine the projection surface information according to the depth information. Specifically, this step is used to analyze height variations in the depth data to identify a continuous pixel range where a height value conforms to preset planar features. The projection surface information corresponds to the contour information of the projection surface (such as the desktop) within the projection range. Since the projection surface PS physically has a consistent height (for example, a plane with a height of 0), the processor 140 excludes objects with significant height features (i.e., a physical height greater than a threshold value) through a height filtering algorithm, and the remaining planar area is defined as the projection surface PS.

In step S1230, the processor 140 may determine the shadow area according to the projection surface information. Specifically, within a determined planar range, image color information is further analyzed to search for dark color blocks generated by light obstruction. In processing, the processor 140 may compare color information within the range of the projection surface PS. Since the shadows appear at the same height as the projection surface PS in the depth information, pixel image information thereof (such as red-green-blue RGB values, hue-saturation-lightness HSL values, or hue-saturation-value HSV values) will be significantly lower than other areas of the projection surface PS. The processor 140 marks darker colored portions on the projection surface PS as shadows (belonging to the shadow areas) through results of comparing the color information.

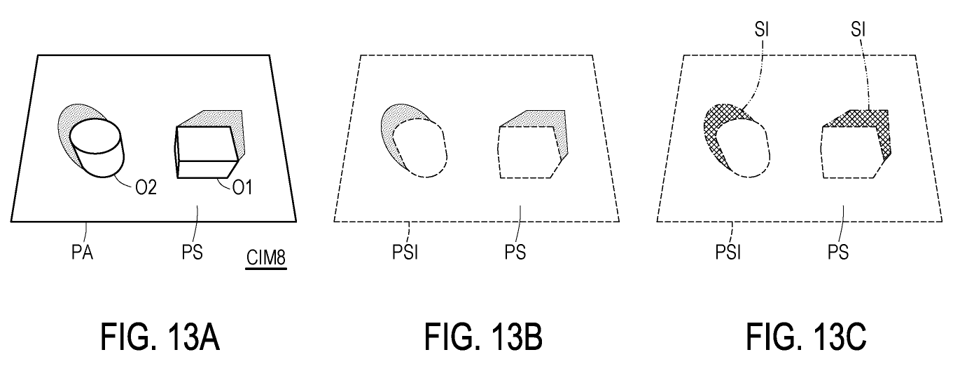

For example, FIGS. 13A-13C are schematic diagrams of segmentation of a shadow area according to still another embodiment of the disclosure. Referring to FIG. 13A, the processor 140 obtains a captured image CIM8 corresponding to an area where the objects O1 and O2 are located, and obtains the corresponding depth information at the same time. Referring to FIG. 13B, after analyzing the depth information, the processor 140 identifies the projection surface PS that does not have the physical height and is located at a bottom layer, and defines it as the projection surface information PSI using the contour information thereof. Referring to FIG. 13C, within an area where the height is determined to be planar, the processor 140 detects the areas with the darker colors and marks them as the shadow feature information SI. Subsequently, the processor 140 determines the final shadow area according to the contour features of this shadow feature information SI. Thereby, even under weak ambient light conditions, the projection system 100 may still accurately distinguish between the object area and the shadow area through dual verification of a physical depth and color contrast.

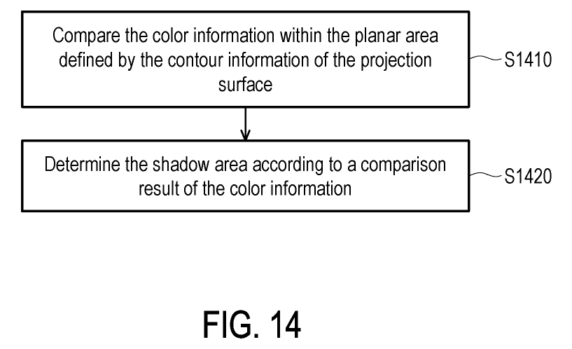

FIG. 14 is a flowchart illustrating determination of a shadow area according to yet another embodiment of the disclosure. This flowchart illustrates the fourth implementation aspect of identifying the shadow area, which involves color comparison. This step is used to ensure accurate exclusion of misjudgments in scenarios where the ambient light is uneven or the projection surface PS has specific textures.

Referring to FIG. 14, in step S1410, the processor 140 may compare the color information within the planar area defined by the contour information of the projection surface. Specifically, the planar area is a two-dimensional virtual block enclosed by a contour boundary of the projection surface PS, and is used to limit a computational range of a subsequent color analysis. The planar area represents a surface within the projection range that the processor 140 determines to be flat and without the physical height (for example, the height equal to zero), and defines the planar area accordingly. The processor 140 analyzes the color, brightness, or grayscale values (such as the red-green-blue RGB values, the hue-saturation-lightness HSL values, or the hue-saturation-value HSV values) of each of pixels within the planar area to determine whether a brightness difference exists.

In step S1420, the processor 140 determines the shadow area according to a comparison result of the color information. Specifically, this step is used to distinguish the dark area caused by uneven lighting within the planar area. The processor 140 compares brightness levels of different coordinate points within the planar area. If a brightness value of a specific area is significantly lower than an average brightness threshold value of the planar area, the processor 140 marks the area as the shadow feature information SI, and determines the final shadow area accordingly. By limiting the color comparison within the predefined planar area, the processor 140 may avoid mistaking dark textures on object sides as the shadows, thereby accurately identifying actual shadow positions on the projection surface PS.

Referring to FIG. 4, in step S430, the processor 140 determines the projection area within the projection range according to the object area and the shadow area. Specifically, this step is used to calculate available space within the projection range that is not interfered with by the objects and the shadows. The processor 140 defines the identified object area and shadow area as non-projectable areas, and defines all or a part of the remaining available range within the projection range as the projection area. The projection area corresponds to an actual imaging position for subsequently projecting the extended information.

In step S440, the processor 140 generates the extended information of the object. Specifically, the extended information is analytical content based on an object category, attributes, or related application requirements obtained from identifying the object, and visual content to be projected onto the projection surface PS is generated through the artificial intelligence model. The extended information may be textual descriptions about the object, function menus, interactive control buttons, or decorative images. For example, if the object corresponding to the object area is a book, the extended information generated by the artificial intelligence model may be introductory content about the book or page-turning control icons. The artificial intelligence model may learn in advance associations between input data and input information thereof.

In step S450, the processor 140 projects the extended information to the projection area through the projector 110. Specifically, this step involves controlling the projector 110 to accurately display generated digital content within the predetermined available space. Since the extended information is projected in the projection area that avoids the object area and the shadow area, the user may clearly see the complete content without information obstruction. Display adjustment strategies for the extended information (such as automatic size scaling, insufficient space prompts, orientation detection correction, and dynamic position tracking, etc.) will be described in detail in subsequent embodiments.

In one embodiment, the projection area includes one or more active areas of non-connected extended portions. The processor 140 may project the extended information to only one of the one or more active areas of non-connected extended boundaries through the projector 110.

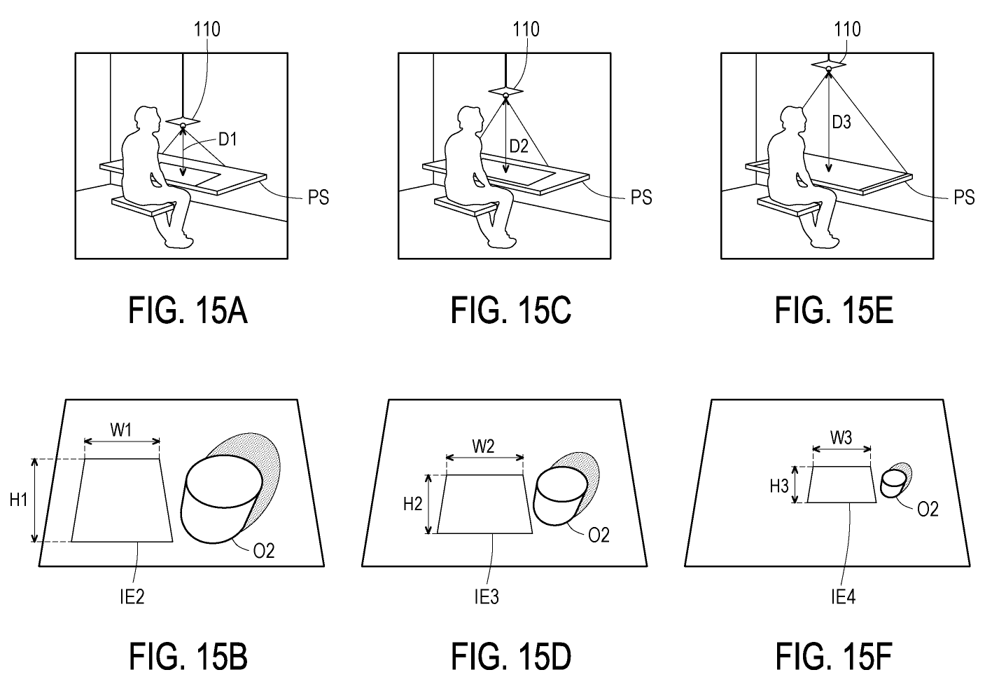

After determining the shadow area, the processor 140 further considers a physical scale of a projection environment. In one embodiment, FIGS. 15A-15F are schematic diagrams illustrating sizes of a projection range and extended information according to an embodiment of the disclosure. Specifically, the processor 140 may adjust a width value and a height value of the extended information according to total size information of the projection range. The total size information refers to a maximum imaging area or a range thereof covered by the projector 110 on the projection surface PS. The processor 140 detects a physical distance between the projector 110 and the projection surface PS, and calculates the projection range accordingly.

For example, referring to FIGS. 15A and 15B , when the projector 110 and the projection surface PS are at a distance D1, the projection range PA corresponds to a first size. The processor 140 generates extended information IE2 having a width value W1 and a height value H1 according to the first size. Assuming that the projection range PA is not greater than 20 inches, the width value W1 corresponding to the extended information IE2 is between thirty percent to fifty percent of a width value of the projection range PA, and the height value H1 corresponding to the extended information IE2 is between twenty percent to forty percent of a height value of the projection range PA.

Referring to FIGS. 15C and 15D , when the physical distance increases to a distance D2 (greater than the distance D1), the projection range PA expands accordingly. The processor 140 detects that the total size information becomes larger, and then adjusts a size of extended information IE3 to a width value W2 and a height value H2. Assuming that the projection range PA is greater than 20 inches but less than 60 inches, the width value W2 corresponding to the extended information IE3 is between twenty percent to forty percent of the width value of the projection range PA, and the height value H2 corresponding to the extended information IE3 is between ten percent to thirty percent of the height value of the projection range PA.

Referring to FIGS. 15E and 15F , when the physical distance increases to a distance D3 (greater than the distance D2), a width or a height of the extended information IE1 may be set to a fixed proportion of a total width or a total height of the projection range PA, and then adjust a size of extended information IE4 to a width value W3 and a height value H3. Assuming that the projection range is greater than 60 inches, the width value W3 corresponding to the extended information IE4 is between ten percent to thirty percent of the width value of the projection range PA, and the height value H3 corresponding to the extended information IE4 is between seven percent to twenty percent of the height value of the projection range PA.

Thereby, the extended information IE1 maintains a consistent visual proportion under different projection distances.

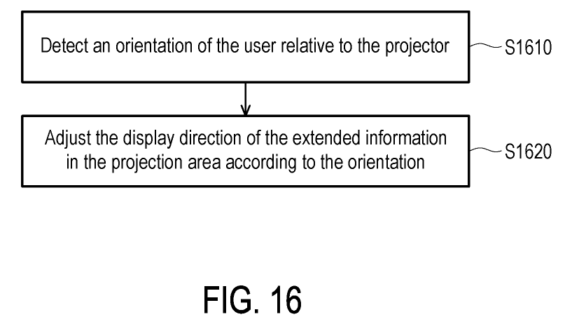

In addition to size adjustment, the processor 140 may also adjust a display angle. FIG. 16 is a flowchart illustrating determination of a display direction according to an embodiment of the disclosure. Referring to FIG. 16, in step S1610, the processor 140 may detect an orientation of the user relative to the projector 110. Specifically, this step is used to identify a geometric position or a sight projection point of the user relative to the projection system 100 in the physical space. The processor 140 drives the image capturing device 120 to capture environmental images including the user, and identifies face, shoulder, or body torso features of the user through the built-in artificial intelligence model. By calculating the spatial coordinates of these features in the captured image, the processor 140 may determine the sight direction of the user. For example, when the user moves to different sides of the projection surface PS, the processor 140 updates coordinate parameters representing the orientation of the user in real time.

In step S1620, the processor 140 adjusts the display direction of the extended information in the projection area according to the orientation. Specifically, this step is used to change a rotation angle or arrangement polarity of the extended information on the projection surface PS to maintain alignment with the sight direction of the user. The processor 140 may convert detected orientation information into display rotation commands. For example, if the orientation information shows that the user is located at a side of the projection area, the processor 140 controls the projector 110 to rotate the extended information by ninety degrees or one hundred eighty degrees.

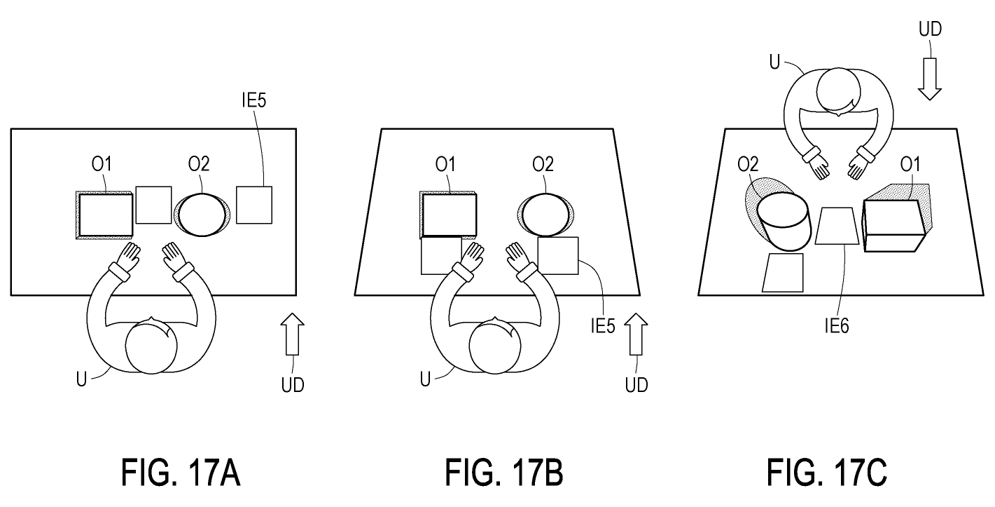

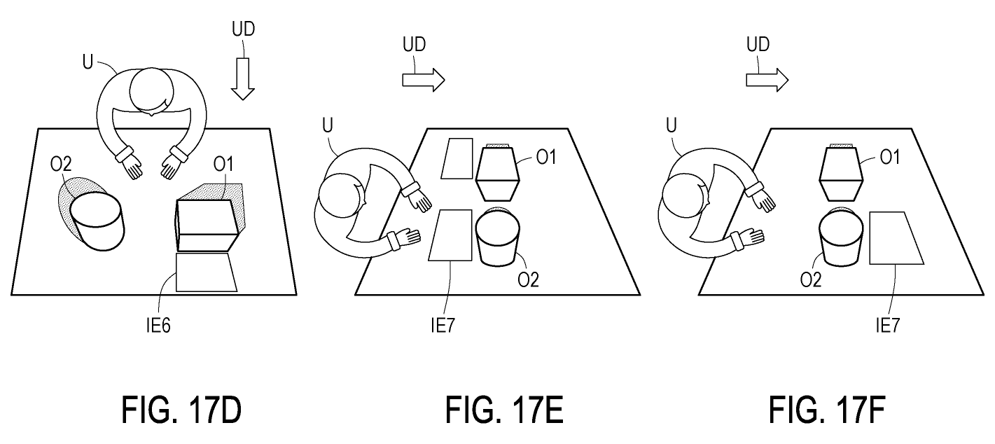

For example, FIGS. 17A-17F are schematic diagrams illustrating extended information and a display direction thereof according to an embodiment of the disclosure. As shown in FIGS. 17A and 17B , when the user U is located at a first orientation (such as a lower part of the drawing), the processor 140 projects extended information IE5 in a first display direction (such as a forward direction). Referring to FIGS. 17C and 17D , when the user U moves to a second orientation (such as the upper part of the drawing), the processor 140 detects a change in the orientation and rotates extended information IE6 to a second display direction, so that the content still faces the user U for convenient reading. Referring to FIGS. 17E and 17F , when the user U moves to a third orientation (such as a left side of the drawing), the processor 140 detects the change in the orientation and rotates extended information IE7 to a third display direction, so that the content still faces the user U for convenient reading.

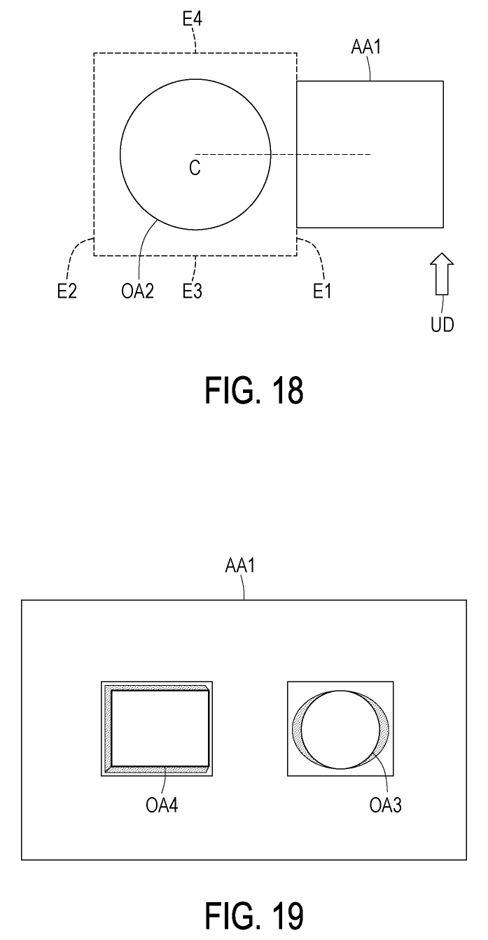

In one embodiment, for the active area, the processor 140 may establish the bounding box for the object area corresponding to the object and analyze a geometric relationship between each of edges of the bounding box and the shadow area. For example, FIG. 18 is a schematic diagram illustrating a connected boundary and the active area AA1 according to an embodiment of the disclosure. As shown in FIG. 18, when the sight direction UD is toward the upper part of the drawing, the processor 140 detects that the object boundaries E3 and E4 of the object area OA2 are connected to the shadow area, and therefore identifies the object boundaries E3 and E4 as the connected boundaries, and extends the active area AA1 from the object boundary E1 (i.e., the non-connected boundary). The active area AA1 may be used to present the extended information, and the extended information may be horizontally centered and aligned with a center C of the object area OA2.

FIG. 19 is a schematic diagram illustrating the active area AA1 according to an embodiment of the disclosure. Referring to FIG. 19, in any case, areas outside the object areas OA3 and OA4 may form the active area AA1.

In one embodiment, when the processor 140 identifies multiple non-connected boundaries (such as the object boundaries E1 and E2), it may further select one from the object boundaries according to a priority order for projecting the extended information. When there are multiple active areas available for display, an optimal display position may be determined according to preset orientation weights to conform to reading habits of the user. Directions corresponding to the priority order are sequentially a right side, left side, lower side, and upper side. The above directions are relative to the sight direction UD of the user U. The processor 140 starts scanning from a direction with high priority to confirm whether the corresponding active area meets a size threshold value and is not obstructed.

For example, as shown in FIG. 18, the object boundary E1 is located on the right side of the object area OA1, while the object boundary E2 is located on the left side. Since the priority of the right side is higher than that of the left side, and the active area AA1 extended from the object boundary E1 meets display space requirements, the processor 140 preferentially selects the object boundary E1 on the right side. Therefore, the processor 140 projects the extended information within then active area AA1, and will not project it in the active area extended from the object boundary E2 located on the left side. Through this priority mechanism, the projection system 100 may automatically find a position that best conforms to a visual logic of the user among multiple available areas.

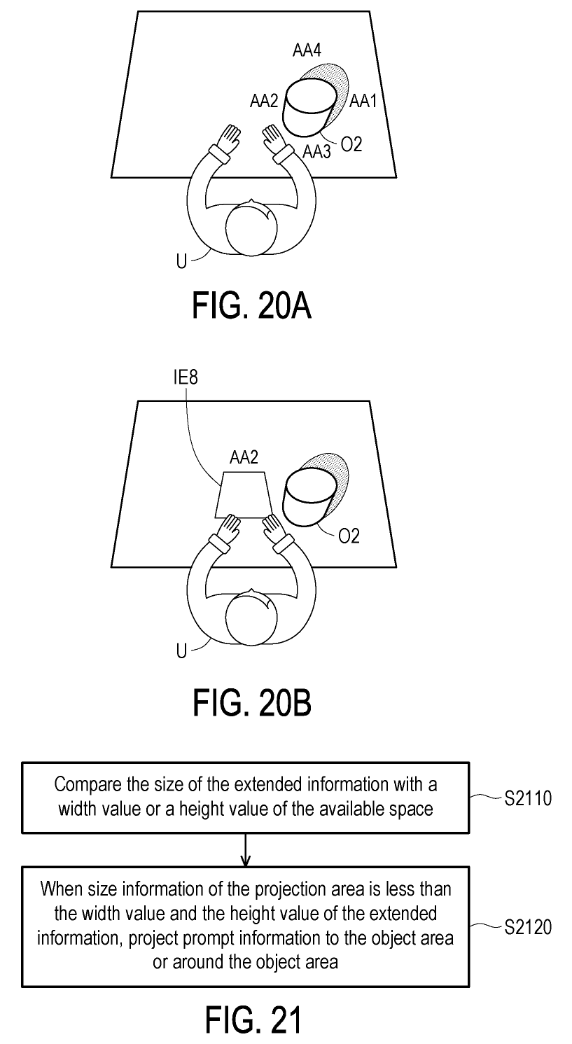

In addition, the position of the active area is dynamically adjusted as the environment changes. FIGS. 20A and 20B are schematic diagrams illustrating dynamic adjustment of an active area according to an embodiment of the disclosure. Referring to FIGS. 20A and 20B , when the object O2 or the light source is displaced, causing the shadow area to change the position, the processor 140 performs boundary identification again and moves imaging coordinates of extended information IE8. The processor 140 continuously monitors the captured image. If an originally non-connected boundary is detected to be transformed into a connected boundary, the processor 140 immediately cancels the corresponding active area and searches for other non-connected boundaries that meet the priority order under the latest state.

For example, the non-connected boundary corresponding to the active area AA1 shown in FIG. 20A has been transformed into a connected boundary. Therefore, the processor 140 further evaluates whether the object boundaries corresponding to other active areas AA2, AA3, and AA4 of other object boundaries are non-connected boundaries and the corresponding priority order thereof. Assuming that the object boundary corresponding to the active area AA2 on the left side of the object O2 is still a non-connected boundary, then active area AA2 as shown in FIG. 20B is selected as an area prioritized for presenting the extended information IE8 according to the priority order. Through this dynamic adjustment, it may be ensured that the extended information always avoids shadow obstruction, maintaining integrity and clarity of the display content.

In one embodiment, the processor 140 may select one from the object boundaries for projecting the extended information according to an overlapping area between the active area and the shadow area. Specifically, the overlapping area is a pixel ratio or a geometric intersection range covered or obstructed by the shadow area in each of the candidate active areas. The processor 140 scans the image features within the candidate active areas (such as the active areas AA1 to AA4 shown in FIG. 20A). If the overlapping area between the specific active area and the shadow area is greater than a threshold value (for example, exceeding ten percent of the area of the region), the processor 140 determines that display quality of this active area is poor.

The processor 140 may compare sizes of the overlapping areas of different active areas, and preferentially select the object boundary with the smallest overlapping area as the projection position. For example, referring to FIGS. 18 and 19 , assuming that the active area AA1 on the right side meets a right-side priority principle, but due to a skewed angle of the light source, most of the range of the active area AA1 overlaps the shadow area. At this time, the processor 140 detects that the overlapping area of the active area AA1 on the right side is greater than the overlapping area of the active area AA2 on the left side, the processor 140 then abandons the object boundary E1 on the right side and instead selects the object boundary E2 on the left side to project the extended information. Through this evaluation mechanism of the overlapping area, the projection system 100 may avoid areas with severe shadow interference, ensuring a presentation effect of the extended information.

In some embodiments, when the space within the projection area is reduced due to object movement or environmental constraints, the processor 140 may further execute optimization strategies for the display content.

FIG. 21 is a flowchart illustrating position adjustment of prompt information according to an embodiment of the disclosure. Referring to FIG. 21, the processor 140 may detect the available space of the projection area. Specifically, this step is used to calculate a continuous geometric range not occupied by the object area and the shadow areas in the projection area, and obtain corresponding width information and height information. In processing, the processor 140 scans boundary coordinates of the active area to define a rectangular range that may completely render digital content. For example, the processor 140 detects whether the remaining width of the current active area is sufficient to accommodate the original size of the extended information.

In step S2110, the processor 140 may compare the size of the extended information with a width value or a height value of the available space. Specifically, this step is used to determine whether the content intended to be projected is obstructed or truncated by the object area or the shadow area. In processing, the processor 140 compares the width value (such as the width values W1 to W3 shown in FIGS. 15A-15C ) or the height value (such as the height values H1 to H3 shown in FIGS. 15A-15C ) of the extended information with an actual pixel edge length of the available space. If the width value or the height value is greater than the available space, it is determined that there is insufficient space.

In step S2120, the processor 140 may compare size information of the projection area with the width value and the height value of the extended information. Specifically, when the insufficient space is detected (for example, the size information of the projection area is less than the width value and the height value of the extended information), by reselecting the active area or simplifying the content, integrity of information transmission is ensured. In processing, the processor 140 searches for other active areas extended from the non-connected boundaries according to the aforementioned priority order, or converts the extended information into the prompt information that occupies smaller space. The prompt information may be simplified icons or text labels, or the projected prompt information is located in the object area or around a periphery of the object area.

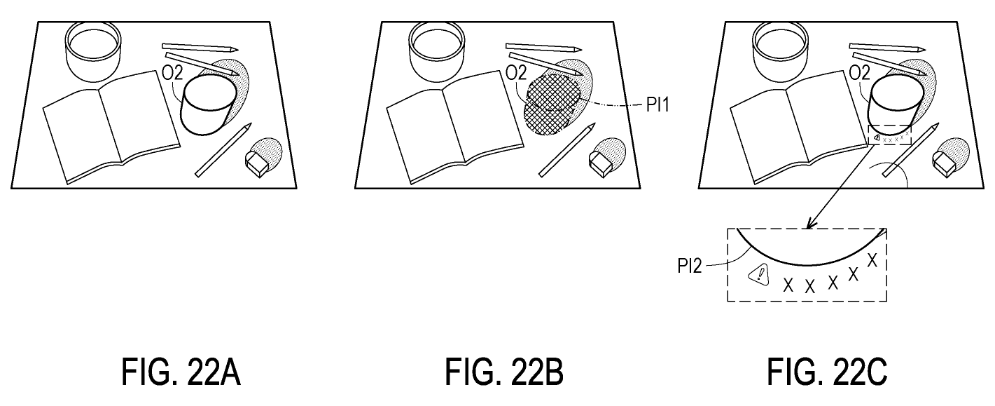

For example, FIGS. 22A-22C are schematic diagrams illustrating adjustment of a display position according to an embodiment of the disclosure. Referring to FIG. 22A, the processor 140 detects that the width value of a certain active area is insufficient to accommodate the extended information corresponding to the object O2. Referring to FIG. 22B, a projected color area (for example, a full red block, serving as prompt information PI1) may directly cover an area where the object O2 is located (i.e., the object area). Alternatively, as shown in FIG. 22C, the processor 140 evaluates the available space beside the object O2, and surrounds prompt information PI2 such as “insufficient projection area” around a periphery of the object O2. Through this mechanism of space evaluation and display mode conversion, the projection system 100 may ensure that important information is not obstructed by the objects or the shadows even under extremely constrained space.

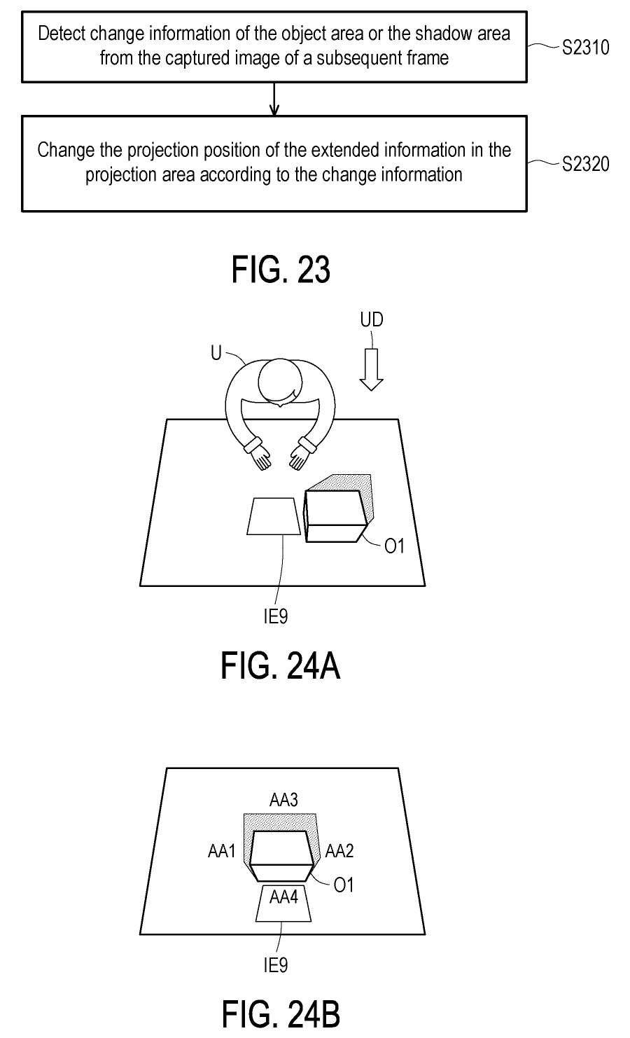

In some embodiments, the projection system 100 is equipped with a capability of dynamically tracking the objects to cope with situations where the objects generate displacement on the projection surface PS. FIG. 23 is a flowchart illustrating object tracking according to an embodiment of the disclosure.

Referring to FIG. 23, in step S2310, the processor 140 may detect change information of the object area or the shadow area from the captured image of a subsequent frame. Specifically, the change information corresponds to positional changes of areas. Through comparison of continuous images, positional differences, shape changes, or area increases and decreases of the object area or the shadow area at different time points may be identified. The processor 140 analyzes the captured image of the subsequent frame and calculates a displacement vector of bounding box coordinates of the object area relative to a previous frame. Meanwhile, the processor 140 also monitors whether the shadow area generate a positional shift due to light source displacement or object movement. For example, the processor 140 may detect change information of center point coordinates of the object area moving from first coordinates to second coordinates.

In step S2320, the processor 140 may change the projection position of the extended information in the projection area according to the change information. Specifically, the latest object and the shadow state may be used to recalculate available projection space and synchronously update imaging points of the digital content. The processor 140 introduces the change information into coordinate calculations to redetermine boundaries of the active area. Subsequently, the processor 140 corrects projection parameters of the extended information, so that the projection position thereof may be synchronously displaced with dynamic targets, thereby maintaining a relative geometric relationship between the extended information and the object.

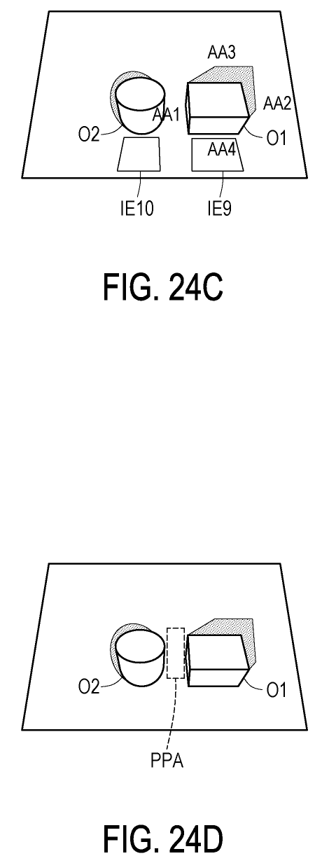

For example, FIGS. 24A-24D are schematic diagrams illustrating object tracking according to an embodiment of the disclosure. Referring to FIG. 24A, when the object O1 is located at an initial position, the processor 140 determines to project extended information IE9 in the active area AA1 on the right side according to the priority order. Referring to FIG. 24B, as the light source changes, the object boundary corresponding to the active area AA1 may change to a connected boundary. Therefore, the extended information IE9 moves to the active area AA4 for presentation.

Referring to FIG. 24C, in another application scenario, with the appearance of the object O2, the extended information IE9 moves to the active area AA4 for presentation, and extended information IE10 corresponding to the object O2 is also presented on the same side as the extended information IE9. Referring to FIG. 24D, an area between the objects O2 and O4 is a non-projectable area PPA. The non-projectable area PPA is a slit block located between the two adjacent object areas and is disadvantageous for displaying the complete extended information due to insufficient width or height. At this time, a width value of the non-projectable area PPA is, for example, less than twenty percent of size information of the corresponding projection area of the extended information IE9. When such a narrow space is detected, the processor 140 marks this location as an avoidance area, and moves the extended information to a more spacious available space.

Based on the above, in the image projection method and the projection system in the embodiments of the disclosure, the image information of the projection surface is obtained, and the object area and the shadow area are accurately identified by using technologies such as artificial intelligence identification, depth information filtering, and color information comparison. By identifying the non-connected boundaries in the bounding box that are not connected to the shadow area, in the embodiments of the disclosure, the active area is defined, and the optimal projection position and display angle of the extended information are determined according to the preset priority order, overlapping area determination, or the sight direction of the user. In addition, the embodiments of the disclosure are equipped with dynamic adjustment and tracking mechanisms that may adjust the size of the extended information according to the projection distance, or convert to the prompt information when the space is insufficient, and update the projection coordinates in real time as the objects move. Thereby, the issue of information being blocked by the objects or the shadows is effectively solved, greatly improving the stability of interactive projection and the transmission effect of visual information.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An image projection method, implemented by a processor, wherein the image projection method comprises:
obtaining a captured image, wherein the captured image corresponds to a projection range of a projector;
identifying an object area and a shadow area from the captured image, wherein the object area corresponds to at least one object, and the object area is connected to the shadow area;
determining a projection area within the projection range according to the object area and the shadow area, wherein the object area and the shadow area are outside the projection area;
generating extended information of the at least one object; and
projecting the extended information to the projection area through the projector.

2. The image projection method according to claim 1, wherein determining the projection area according to the object area and the shadow area comprises:
identifying at least one connected boundary among a plurality of object boundaries of the object area, wherein the at least one connected boundary is connected to the shadow area; and
determining an active area extended by at least one non-connected boundary among the object boundaries, wherein the at least one non-connected boundary is not connected to the shadow area, and the projection area comprises the active area extended by the at least one non-connected boundary.

3. The image projection method according to claim 2, wherein projecting the extended information to the projection area through the projector comprises:
projecting the extended information only to one of the active areas extended by the at least one non-connected boundary.

4. The image projection method according to claim 1, wherein projecting the extended information to the projection area through the projector comprises:
selecting one from the object boundaries for projecting the extended information according to a priority order of a plurality of object boundaries of the object area, wherein directions corresponding to the priority order are sequentially right, left, down, and up.

5. The image projection method according to claim 1, wherein projecting the extended information to the projection area through the projector comprises:
selecting one from the object boundaries for projecting the extended information according to an overlapping area between an active area respectively extended by a plurality of object boundaries of the object area and the shadow area.

6. The image projection method according to claim 1, wherein identifying the object area and the shadow area from the captured image comprises:
obtaining shadow feature information from the captured image through an artificial intelligence model, wherein the shadow feature information corresponds to contour information of the shadow area; and
determining the shadow area according to the shadow feature information.

7. The image projection method according to claim 1, wherein identifying the object area and the shadow area from the captured image comprises:
obtaining projection surface information from the captured image through an artificial intelligence model, wherein the projection surface information corresponds to contour information of a projection surface within the projection range;
obtaining shadow feature information from the projection surface information, wherein the shadow feature information corresponds to contour information of the shadow area; and
determining the shadow area according to the shadow feature information.

8. The image projection method according to claim 1, wherein identifying the object area and the shadow area from the captured image comprises:
obtaining depth information of the projection range from the captured image;
determining projection surface information according to the depth information, wherein the projection surface information corresponds to contour information of a projection surface within the projection range; and
determining the shadow area according to the projection surface information.

9. The image projection method according to claim 8, wherein determining the shadow area according to the projection surface information comprises:
comparing color information within a planar area defined by the contour information of the projection surface; and
determining the shadow area according to a comparison result of the color information.

10. The image projection method according to claim 1, wherein projecting the extended information to the projection area through the projector comprises:
adjusting a width value and a height value of the extended information according to total size information of the projection range.

11. The image projection method according to claim 1, wherein projecting the extended information to the projection area through the projector comprises:
comparing size information of the projection area with a width value and a height value of the extended information; and
when the size information of the projection area is less than the width value and the height value of the extended information, projecting prompt information to the object area or around a periphery of the object area.

12. The image projection method according to claim 1, wherein projecting the extended information to the projection area through the projector comprises:
detecting an orientation of a user relative to the projector; and
adjusting a display direction of the extended information in the projection area according to the orientation.

13. The image projection method according to claim 1, further comprising:
detecting change information of the object area or the shadow area from the captured image of a subsequent frame, wherein the change information corresponds to a positional change of an area; and
changing a projection position of the extended information in the projection area according to the change information.

14. A projection system, comprising:
a projector;
an image capturing device configured to obtain a captured image, wherein the captured image corresponds to a projection range of the projector;
a processor communicatively connected to the projector and the image capturing device, and configured to:
identify an object area and a shadow area from the captured image, wherein the object area corresponds to at least one object, and the object area is connected to the shadow area;
determine a projection area within the projection range according to the object area and the shadow area, wherein the object area and the shadow area are outside the projection area;
generate extended information of the at least one object; and
project the extended information to the projection area through the projector.

15. The projection system according to claim 14, wherein the processor is further configured to:
identify at least one connected boundary among a plurality of object boundaries of the object area, wherein the at least one connected boundary is connected to the shadow area; and
determine an active area extended by at least one non-connected boundary among the object boundaries, wherein the at least one non-connected boundary is not connected to the shadow area, and the projection area comprises the active area extended by the at least one non-connected boundary.

16. The projection system according to claim 15, wherein the processor is further configured to:
project the extended information only to one of the active areas extended by the at least one non-connected boundary.

17. The projection system according to claim 14, wherein the processor is further configured to:
select one from the object boundaries for projecting the extended information according to a priority order of a plurality of object boundaries of the object area, wherein directions corresponding to the priority order are sequentially right, left, down, and up.

18. The projection system according to claim 14, wherein the processor is further configured to:
select one from the object boundaries for projecting the extended information according to an overlapping area between an active area respectively extended by a plurality of object boundaries of the object area and the shadow area.

19. The projection system according to claim 14, wherein the processor is further configured to:
obtain shadow feature information from the captured image through an artificial intelligence model, wherein the shadow feature information corresponds to contour information of the shadow area; and
determine the shadow area according to the shadow feature information.

20. The projection system according to claim 14, wherein the processor is further configured to:
obtain projection surface information from the captured image through an artificial intelligence model, wherein the projection surface information corresponds to contour information of a projection surface within the projection range;
obtain shadow feature information from the projection surface information, wherein the shadow feature information corresponds to contour information of the shadow area; and
determine the shadow area according to the shadow feature information.

21. The projection system according to claim 14, wherein the processor is further configured to:
obtain depth information of the projection range from the captured image;
determine projection surface information according to the depth information, wherein the projection surface information corresponds to contour information of a projection surface within the projection range; and
determine the shadow area according to the projection surface information.

22. The projection system according to claim 21, wherein the processor is further configured to:
compare color information within a planar area defined by the contour information of the projection surface; and
determine the shadow area according to a comparison result of the color information.

23. The projection system according to claim 14, wherein the processor is further configured to:
adjust a width value and a height value of the extended information according to total size information of the projection range.

24. The projection system according to claim 14, wherein the processor is further configured to:
compare size information of the projection area with a width value and a height value of the extended information; and
when the size information of the projection area is less than the width value and the height value of the extended information, project prompt information to the object area or around a periphery of the object area.

25. The projection system according to claim 14, wherein the processor is further configured to:
detect an orientation of a user relative to the projector; and
adjust a display direction of the extended information in the projection area according to the orientation.

26. The projection system according to claim 14, wherein the processor is further configured to:
detect change information of the object area or the shadow area from the captured image of a subsequent frame, wherein the change information corresponds to a positional change of an area; and
change a projection position of the extended information in the projection area according to the change information.
